(19) United States
(12) Patent Application Publication
(10) Pub. No.: US 2014/0368750 A1
(43) Pub. Date: Dec. 18, 2014

(54) SINGLE-LAYER MUTUAL CAPACITIVE TOUCH SCREEN

(71) Applicant: NOVATEK Microelectronics Corp., Hsin-Chu (TW)

(72) Inventors: Jian-Cheng Liao, Hsinchu City (TW); Chih-Chang Lai, Taichung City (TW)

(73) Assignee: NOVATEK Microelectronics Corp., Hsin-Chu (TW)

(21) Appl. No.: 14/072,799

(22) Filed: Nov. 6, 2013

(30) Foreign Application Priority Data
Jun. 18, 2013 (TW) 102121615

(51) Int. Cl. G06F 1/16; G06F 3/044

(52) U.S. Cl. CPC G06F 1/169; G06F 3/044
USPC 349/12

(57) ABSTRACT

A single-layer mutual capacitive touch screen includes a substrate; a control circuit, disposed at a side of the substrate; a plurality of touch sensing electrodes, arranged on the substrate in an N×M array and classified into a first group and a second group; a plurality of output pins, for connecting the control circuit to the plurality of touch sensing electrodes; and a plurality of driving wires, each connecting a touch sensing electrode and an output pin. In the first group, each touch sensing electrode located at odd columns of the N×M array substantially shares an output pin with an adjacent touch sensing electrode located in a first direction of the touch sensing electrode. In the second group, each touch sensing electrode located at even columns of the N×M array substantially shares an output pin with an adjacent touch sensing electrode located in the first direction of the touch sensing electrode.

### BACKGROUND OF THE INVENTION

1. Field of the Invention

The present invention relates to a single-layer mutual capacitive touch screen, and more particularly, to a mutual capacitive touch screen with a single-layer structure and multi-touch functions capable of reducing numbers of output pins and connecting wires for touch sensing electrodes by adjusting a disposition of the connecting wires.

2. Description of the Prior Art

In recent years, touch sensing technology have advanced at such a pace that many consumer electronic products including mobile phones, GPS navigator systems, tablets, personal digital assistants (PDA) and laptops are equipped with touch sensing functions. In many electronic products, touch sensing functions are included in a display area which originally only comprised display functions. In other words, an original display panel is replaced by a touch screen capable of both display and touch sensing functions. The touch screen can generally be divided into out-cell, in-cell and on-cell touch screen according to the difference in the structure of the touch screen. The out-cell touch screen is composed of an independent touch screen and a general display panel. In the in-cell and on-cell touch screen, a touch sensing device is directly disposed inside and outside of a substrate in the display panel, respectively.

Touch sensing techniques can be classified into a resistive type, capacitive type and optical type. The capacitive type touch screens have become more popular over time as they have many advantages such as high sensing accuracy, high transparency, high reaction speed and long life. The capacitive touch screens can further be classified into two types: self capacitance and mutual capacitance. The self capacitive touch screens cannot sense a multi-touch accurately, and are usually applied in electronic products with only single-touch sensing functions or devices with smaller display areas. In comparison, the mutual capacitive touch screens are capable of performing multi-touch sensing functions and other complex touch sensing functions for larger display areas. The cost and complexity of single-layer mutual capacitive touch screens are lower than conventional mutual capacitive touch screens with a multi-layer structure.

In a single-layer structure with multi-touch functions, the touch sensing electrodes and the connecting wires for control devices have to be realized on the same layer of the substrate. Different wires corresponding to different touch sensing electrodes cannot overlap on the substrate. In such a situation, a great number of connecting wires should be disposed on the substrate, which decreases the area for disposing the touch sensing electrodes, such that sensitivity and linearity of touch sensing will be reduced. In addition, such single-layer structure requires a great number of output pins disposed on the substrate to connect the circuits on the substrate to external control devices. The great number of output pins will lead to higher cost and lower yield rate. Thus, there is a need for improvement over the prior art.

### SUMMARY OF THE INVENTION

It is therefore an objective of the present invention to provide a single-layer mutual capacitive touch screen, which is capable of reducing the numbers of output pins and connecting wires for the touch sensing electrodes by disposition of the connecting wires and share of the output pins, in order to achieve benefits such as cost reduction, yield rate improvement and touch sensitivity enhancement.

The present invention discloses a single-layer mutual capacitive touch screen, comprising a substrate; a control circuit, disposed at a side of the substrate; a plurality of touch sensing electrodes, arranged on the substrate in an N×M array and classified into a first group and a second group, wherein touch sensing electrodes among the plurality of touch sensing electrodes located in a same row are classified into a same group; a plurality of output pins, located at the side of the substrate, for connecting the control circuit to the plurality of touch sensing electrodes; and a plurality of driving wires, each connecting a touch sensing electrode among the plurality of touch sensing electrodes to an output pin among the plurality of output pins, respectively; wherein in the first group, each touch sensing electrode located at odd columns of the N×M array substantially shares an output pin with an adjacent touch sensing electrode located in a first direction of the touch sensing electrode; wherein in the second group, each touch sensing electrode located at even columns of the N×M array substantially shares an output pin with an adjacent touch sensing electrode located in the first direction of the touch sensing electrode; and wherein at least one row of touch sensing electrodes in the second group are located between at least two rows of touch sensing electrodes in the first group.

The present invention further discloses a single-layer mutual capacitive touch screen, comprising a substrate; a control circuit, disposed at a side of the substrate; a plurality of touch sensing electrodes, arranged on the substrate in an N×M array; a plurality of output pins, located at the side of the substrate, for connecting the control circuit to the plurality of touch sensing electrodes; and a plurality of driving wires, each connecting a touch sensing electrode among the plurality of touch sensing electrodes to an output pin among the plurality of output pins, respectively; wherein each touch sensing electrode located at the first row of the N×M array is connected to each other via a driving wire, and connected to a corresponding output pin; and wherein each touch sensing electrode located at the N^{th} row of the N×M array is connected to each other via a driving wire, and connected to a corresponding output pin.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the structure of a single-layer mutual capacitive touch screen.

FIG. 2 is a schematic diagram of the disposition of touch sensing electrodes in a single-layer mutual capacitive touch screen.

FIG. 3 is a schematic diagram of the disposition of touch sensing electrodes in a single-layer mutual capacitive touch screen according to an embodiment of the present invention.

FIG. 4 is a schematic diagram of the disposition of touch sensing electrodes in a single-layer mutual capacitive touch screen according to an embodiment of the present invention.

FIG. 5 is a schematic diagram of the disposition of touch sensing electrodes in a single-layer mutual capacitive touch screen according to an embodiment of the present invention.

FIG. 6 is a schematic diagram of the disposition of touch sensing electrodes in a single-layer mutual capacitive touch screen according to an embodiment of the present invention.

FIG. 7 is a schematic diagram of the disposition of touch sensing electrodes in a single-layer mutual capacitive touch screen according to an embodiment of the present invention.

FIG. 8 is a schematic diagram of the disposition of touch sensing electrodes in a single-layer mutual capacitive touch screen according to an embodiment of the present invention.

FIG. 9 is a schematic diagram of the disposition of touch sensing electrodes in a single-layer mutual capacitive touch screen according to an embodiment of the present invention.

FIG. 10 is a schematic diagram of the disposition of touch sensing electrodes in a single-layer mutual capacitive touch screen according to an embodiment of the present invention.

FIG. 11 is a schematic diagram of the disposition of touch sensing electrodes in a single-layer mutual capacitive touch screen according to an embodiment of the present invention.

FIG. 12A to FIG. 12D are schematic diagrams of the disposition of touch sensing electrodes in a single-layer mutual capacitive touch screen according to an embodiment of the present invention.

### DETAILED DESCRIPTION

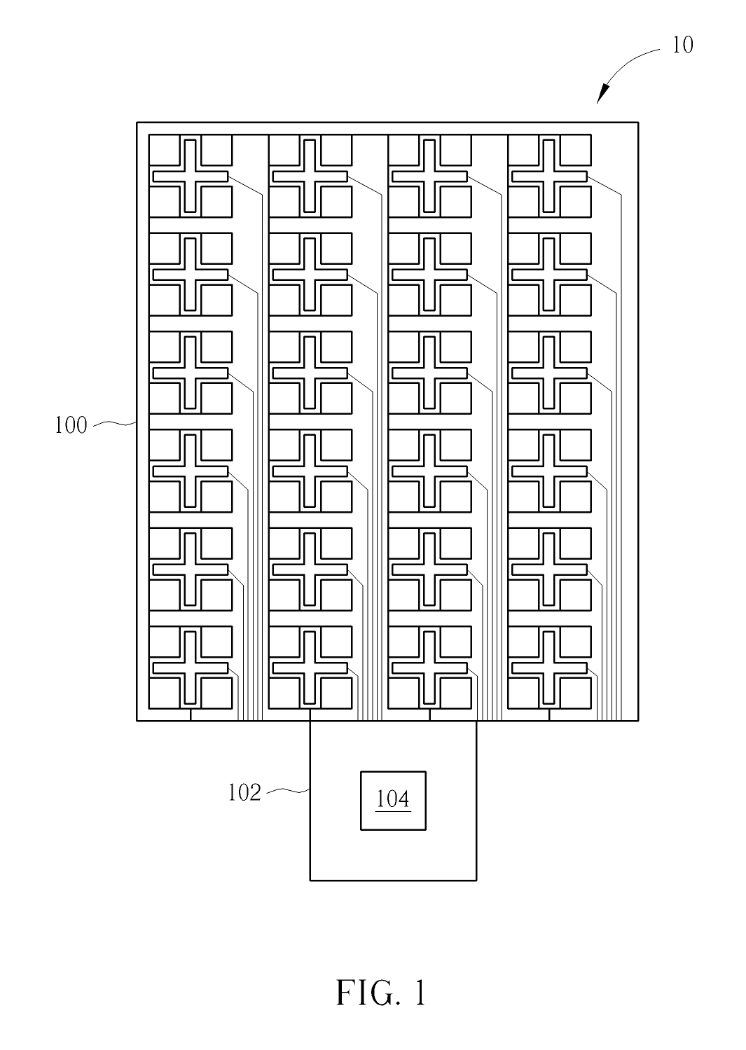

Please refer to FIG. 1, which is a schematic diagram of the structure of a single-layer mutual capacitive touch screen 10. As shown in FIG. 1, the single-layer mutual capacitive touch screen 10 includes a substrate 100, a flexible printed circuit board (FPC) 102 and a control circuit 104. In the single-layer mutual capacitive touch screen 10, each touch sensing electrode, composed of driving areas and receiving areas, is disposed on the substrate 100. The FPC 102 is disposed at a side of the substrate 100. The control circuit 104, located on the FPC 102, is utilized for controlling the operations of touch sensing electrodes on the substrate 100. As shown in FIG. 1, the touch sensing electrodes on the substrate 100 are connected to output pins located at the bottom of the substrate 100 via connecting wires, and then connected outward to the FPC 102 via the output pins, in order to receive control signals from the control circuit 104 on the FPC 102. Each of the driving areas and receiving areas of the touch sensing electrodes is connected to an output pin via a driving wire and a receiving wire, respectively, where the driving wires and receiving wires make up the connecting wires on the substrate 100.

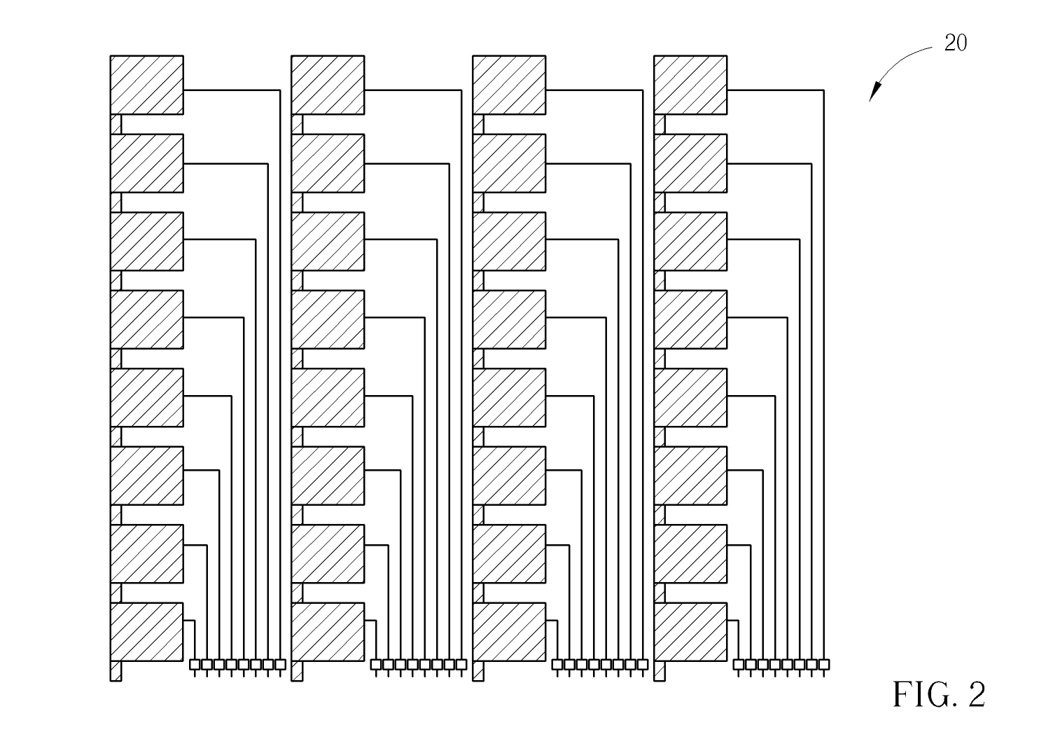

A common disposition method of connecting wires and output pins on the substrate is illustrated in a single-layer mutual capacitive touch screen 20 of FIG. 2. As shown in FIG. 2, the single-layer mutual capacitive touch screen 20 includes 32 touch sensing electrodes arranged in an 8×4 array. Each touch sensing electrode is illustrated as a block for simplicity, where driving areas and receiving areas are connected to output pins below the substrate via driving wires and receiving wires, respectively. Among these 32 touch sensing electrodes, the driving area in each touch sensing electrode is connected downward to an output pin via a driving wire at the right side of the touch sensing electrode; hence, 8 driving wires are disposed at the right side of each column of touch sensing electrodes and connected to the driving areas of 8 touch sensing electrodes at the column, respectively. The receiving areas in the touch sensing electrodes located at the same column are connected up and down to each other via receiving wires, and the bottommost touch sensing electrode in the column is connected downward to an output pin. Thus, for the touch sensing electrodes arranged in an 8×4 array, 32 output pins, respectively corresponding to 32 driving wires, are required to provide outward connecting paths for the driving areas, and 4 output pins, respectively located at the bottom of 4 columns of touch sensing electrodes, are required to provide outward connecting paths for the receiving areas. As a result, a total of 32+4=36 output pins are required.

In order to reduce the numbers of output pins and connecting wires, the method of sharing output pins may be applied. The driving method of a single-layer mutual capacitive touch screen may input driving signals to the driving areas horizontally and receive touch sensing signals from the receiving areas vertically; hence, the receiving areas within the touch sensing electrodes from top to bottom can be connected to each other. Similarly, the driving areas within the touch sensing electrodes from left to right can also be connected to each other; hence, the driving areas within the touch sensing electrodes in the same row can share an output pin.

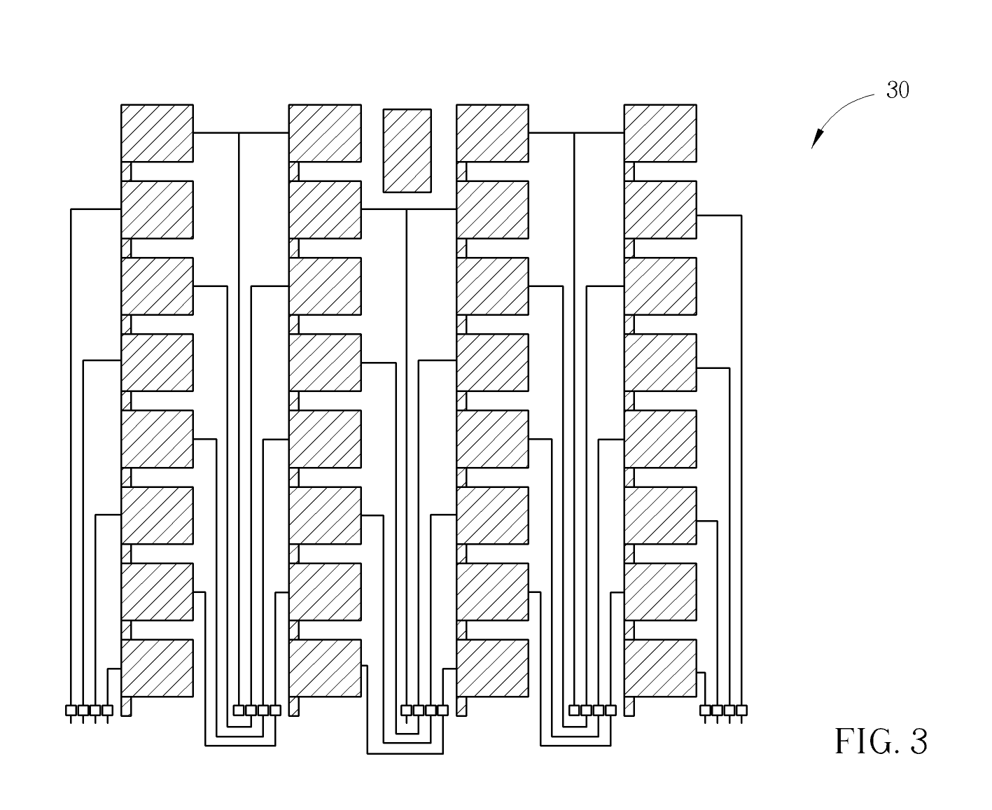

Please refer to FIG. 3, which is a schematic diagram of the disposition of touch sensing electrodes in a single-layer mutual capacitive touch screen 30 according to an embodiment of the present invention. The number and disposition of touch sensing electrodes in the single-layer mutual capacitive touch screen 30 are similar to those in the single-layer mutual capacitive touch screen 20, which also has 32 touch sensing electrodes arranged in an 8×4 array, but the disposition method of driving wires in the single-layer mutual capacitive touch screen 30 is different from that in the single-layer mutual capacitive touch screen 20, where the single-layer mutual capacitive touch screen 30 utilizes fewer output pins. As shown in FIG. 3, in the 1^{st}, 3^{rd}, 5^{th} and 7^{th} rows, the touch sensing electrodes located at the 1^{st} column and the 2^{nd} column share an output pin, and the touch sensing electrodes located at the 3^{rd} column and the 4^{th} column share an output pin. In the 2^{nd}, 4^{th}, 6^{th} and 8^{th} rows, the touch sensing electrodes located at the 2^{nd} column and the 3^{rd} column share an output pin, each touch sensing electrode located at the 1^{st} column is connected to an output pin separately from the left side, and each touch sensing electrode located at the 4^{th} column is connected to an output pin separately from the right side. In such a situation, corresponding to the driving areas and driving wires in the single-layer mutual capacitive touch screen 30, there are 4 output pins at the left side of the 1^{st} column, 4 output pins at the right side of the 4^{th} column and 4 output pins between every two adjacent columns, so that 5×4=20 output pins are required. In addition, there is one output pin at the bottom of each column of touch sensing electrodes corresponding to the receiving areas and receiving wires, so that a total of 20+4=24 output pins are required. In comparison with the disposition of connecting wires in the single-layer mutual capacitive touch screen 20 requiring 36 output pins, the present invention can reduce the number of required output pins, in order to achieve cost reduction and yield rate improvement.

In comparison with the single-layer mutual capacitive touch screen 20, in which 8 driving wires are disposed between every two adjacent columns of touch sensing electrodes, the single-layer mutual capacitive touch screen 30 only requires 7 driving wires disposed between every two adjacent columns of touch sensing electrodes. When the number of driving wires is reduced, the disposition density of touch sensing electrodes will be increased, which enhances touch sensitivity. As shown in FIG. 3, the touch sensing electrodes in the single-layer mutual capacitive touch screen 30 share the output pins in an interleaving way. Due to the features of interleaving and bilateral symmetry, the distribution of connecting wires will be more uniform; hence the resistance of connecting wires is also uniformly distributed, so that the single-layer mutual capacitive touch screen 30 has a better linearity for touch sensing. Moreover, for the disposition of touch sensing electrodes in the single-layer mutual capacitive touch screen 30, there is only a small part at the top between the 2^{nd} column and the 3^{rd} column having no driving wires which is required to be filled with materials in accordance with the touch sensing electrodes (e.g. indium tin oxide (ITO)); hence, the visual uniformity will not be affected due to a large area of optical compensation.

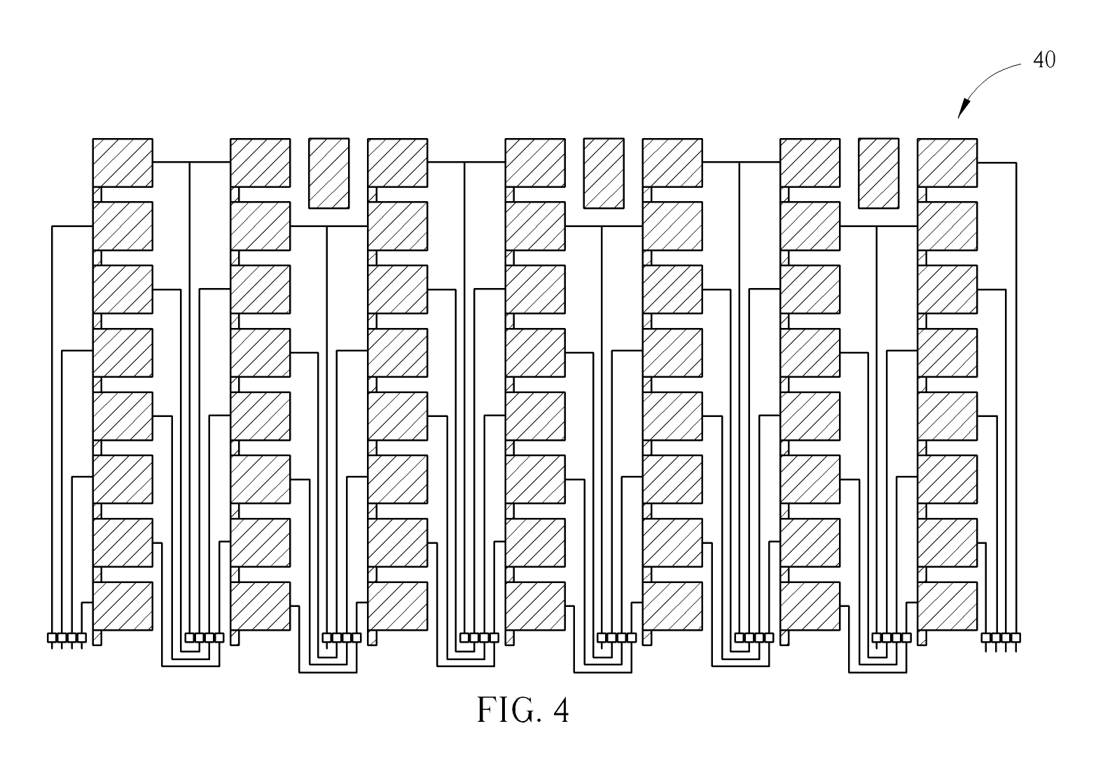

Please note that the single-layer mutual capacitive touch screen 30 shown in FIG. 3 is only one of numerous embodiments of the present invention. If the implementation illustrated in FIG. 3 is applied in a larger touch screen or a touch screen with more touch sensing electrodes, more output pins will be saved. Please refer to FIG. 4, which is a schematic diagram of the disposition of touch sensing electrodes in a single-layer mutual capacitive touch screen 40 according to an embodiment of the present invention. As shown in FIG. 4, the substrate of the single-layer mutual capacitive touch screen 40 has 56 touch sensing electrodes arranged in an 8×7 array. In the 1^{st}, 3^{rd}, 5^{th} and 7^{th} rows, the touch sensing electrodes located at the 1^{st} column and the 2^{nd} column share an output pin, the touch sensing electrodes located at the 3^{rd} column and the 4^{th} column share an output pin, and so on. The redundant touch sensing electrodes located at the 7^{th} column are connected to an output pin separately from the right side. In the 2^{nd}, 4^{th}, 6^{th} and 8^{th} rows, the touch sensing electrodes located at the 2^{nd} column and the 3^{rd} column share an output pin, the touch sensing electrodes located at the 4^{th} column and the 5^{th} column share an output pin, and so on. The touch sensing electrodes located at the 1^{st} column are connected to an output pin separately from the left side. In such a situation, corresponding to the driving areas and driving wires in the single-layer mutual capacitive touch screen 40, there are 4 output pins at the left side of the 1^{st} column, 4 output pins at the right side of the 7^{th} column, and 4 output pins between every two adjacent columns, so that 8×4=32 output pins are required. In addition, there is one output pin at the bottom of each column of touch sensing electrodes corresponding to the receiving areas and receiving wire, so that 32+7=39 output pins are required in total. In comparison, if the connecting wires in the single-layer mutual capacitive touch screen 40 are disposed by using the conventional method illustrated in FIG. 2, there will be a total of 8×7+7=63 output pins required. Therefore, for the touch screen having more touch sensing electrodes, the present invention can reduce the number of required output pins more significantly, in order to achieve cost reduction and yield rate improvement.

The method of disposing the touch sensing electrodes, connecting wires and output pins disclosed in the single-layer mutual capacitive touch screens 30 and 40 can be summarized into a disposition rule. The touch sensing electrodes are arranged on the substrate in an N×M array. These touch sensing electrodes are classified into a first group and a second group, where the touch sensing electrodes located in the same row are classified into the same group. The output pins are disposed at a side at which the control circuit is located, which facilitates signal transmissions for the control circuit to perform driving and sensing on the touch sensing electrodes. In FIG. 3 and FIG. 4, the output pins are located below the substrate. Among all of the connecting wires, each driving wire is utilized for connecting the driving area of a touch sensing electrode to an output pin, and each of the receiving wires is utilized for connecting the receiving area of a touch sensing electrode to an output pin. In order to save the number of output pins, the driving wires for the touch sensing electrodes and corresponding output pins may be disposed in the following way: among the touch sensing electrodes in the first group, each touch sensing electrode located at odd columns of the N×M array substantially shares an output pin with an adjacent touch sensing electrode located in a first direction of the touch sensing electrode; among the touch sensing electrodes in the second group, each touch sensing electrode located at even columns of the N×M array substantially shares an output pin with an adjacent touch sensing electrode located in the first direction of the touch sensing electrode. The first direction may be a direction with an increasing column number corresponding to the N×M array; that is, the right side in FIG. 3 and FIG. 4. In other embodiments, the first direction may also be another direction, which should not be limited herein. The touch sensing electrodes classified into the first group may be those located at odd rows of the N×M array, and the touch sensing electrodes classified into the second group may be those located at even rows of the N×M array.

Among the touch sensing electrodes in the first group and the second group, several touch sensing electrodes in a specific row share an output pin with the adjacent touch sensing electrodes at the right side, and are connected with the adjacent touch sensing electrodes via a driving wire and then connected to the shared output pin. Take the single-layer mutual capacitive touch screen 30 as an example. In the first group, the driving wires of the touch sensing electrodes located at the 1^{st} column and the 2^{nd} column by the 1^{st} row are connected to each other and then connected to the shared output pin, and the driving wires of the touch sensing electrodes located at the 3^{rd} column and the 4^{th} column by the 1^{st} row are connected to each other and then connected to the shared output pin. In the second group, the driving wires of the touch sensing electrodes located at the 2^{nd} column and the 3^{rd} column by the 2^{nd} row are connected to each other and then connected to the shared output pin. Except for the touch sensing electrodes located at the 1^{st} row and the 2^{nd} row, when a touch sensing electrode shares an output pin with the adjacent touch sensing electrode located at the right side, the touch sensing electrode and the right side adjacent touch sensing electrode are connected to the shared output pin separately. In practice, in each group, among the touch sensing electrodes located at the topmost row (i.e. the smallest row number), two adjacent touch sensing electrodes are connected to each other and then connected to an output pin via a driving wire, in order to share the output pin. Among the touch sensing electrodes located at other rows, no matter whether a touch sensing electrode shares an output pin with another one, it should be connected to the output pin via a driving wire separately, in order to prevent different driving wires overlapping on the substrate.

The touch sensing electrodes which cannot share an output pin have to be connected to the output pin separately via a driving wire. For example, in the single-layer mutual capacitive touch screen 30, each touch sensing electrode in the second group located at the 1^{st} column and the 4^{th} column is connected to an output pin separately from the left side and the right side of the array, respectively, and will not share the output pin with other touch sensing electrodes. In the single-layer mutual capacitive touch screen 40, each touch sensing electrode in the second group located at the 1^{st} column and each in the first group located at the 7^{th} column is connected to an output pin separately from the left side and the right side of the array, respectively, and will not share the output pin with other touch sensing electrodes. More specifically, for an arrangement of touch sensing electrodes in an N×M array, the following touch sensing electrodes are connected to an output pin separately without being shared with an adjacent touch sensing electrode: when M is an odd number, each touch sensing electrode in the first group located at the M^{th} column of the N×M array is connected to an output pin separately, and when M is an even number, each touch sensing electrode in the second group located at the M^{th} column of the N×M array is connected to an output pin separately; each touch sensing electrode in the second group located at the 1^{st} column of the N×M array is connected to an output pin separately. For the disposition of the receiving wires and corresponding output pins, the receiving areas of the touch sensing electrodes located at the same column are connected up and down to each other, and then connected downward to an output pin via the bottommost touch sensing electrode.

According to the above method of disposing touch sensing electrodes, in the touch sensing electrodes arranged in the N×M array, (└(N+1)/2┘×└(M+1)/2┘) output pins are required for the driving wires of the touch sensing electrodes in the first group; (└N/2┘×└(M+2)/2┘) output pins are required for the driving wires of the touch sensing electrodes in the second group; and M output pins are required for the receiving wires of all touch sensing electrodes. Under this structure, a total of (└(N+1)/2┘×└(M+1)/2┘+└N/2┘×└(M+2)/2┘+M) output pins are required for the N×M array. For the single-layer mutual capacitive touch screen 30 in which the touch sensing electrodes are arranged in an 8×4 array, (└(8+1)/2┘×└(4+1)/2┘+└8/2┘×└(4+2)/2┘+4)24 output pins are required. For the single-layer mutual capacitive touch screen 40 in which the touch sensing electrodes are arranged in an 8×7 array, (└(8+1)/2┘×└(7+1)/2┘+└8/2┘×└(7+2)/2┘+7)=39 output pins are required. In comparison with the conventional disposition method of the connecting wires where each touch sensing electrode requires an output pin for its driving wire, the present invention can significantly reduce the number of required output pins, in order to achieve cost reduction and yield rate improvement. In the single-layer mutual capacitive touch screens 30 and 40, there are only 7 driving wires disposed between every two adjacent columns of touch sensing electrodes. In comparison with the conventional disposition method of the connecting wires requiring 8 driving wires disposed between two adjacent columns of touch sensing electrodes, the present invention can increase the disposition density of touch sensing electrodes, which enhances the touch sensitivity.

Please note that the present invention provides a single-layer mutual capacitive touch screen capable of reducing the number of output pins and connecting wires by adjusting the disposition of connecting wires and output pins. Those skilled in the art can make modifications and alternations accordingly. For example, in the above single-layer mutual capacitive touch screen, the touch sensing electrodes located at the odd rows are classified into the first group, and the touch sensing electrodes located at the even rows are classified into the second group. In other embodiments, the touch sensing electrodes located at the even rows may be classified into the first group, and those located at the odd rows may be classified into the second group. The classification should not be limited herein. As long as at least one row of touch sensing electrodes in a group is located between at least two rows of touch sensing electrodes in the other group, the interleaving can be achieved, so that the resistance distribution of connecting wires will become more uniform, and the visual uniformity of the screen will also be improved.

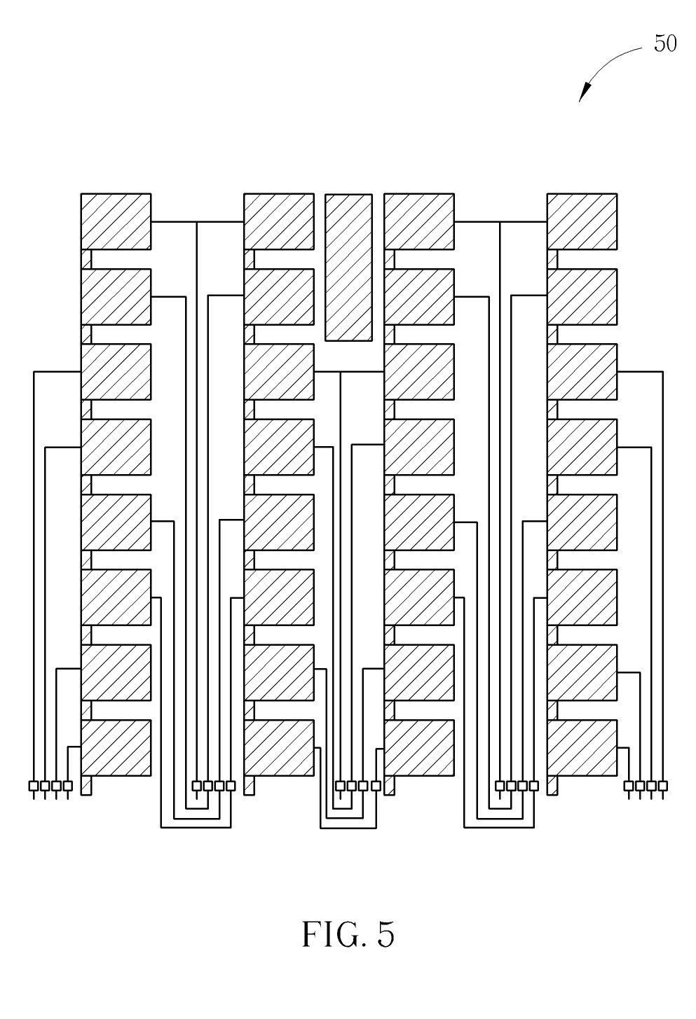

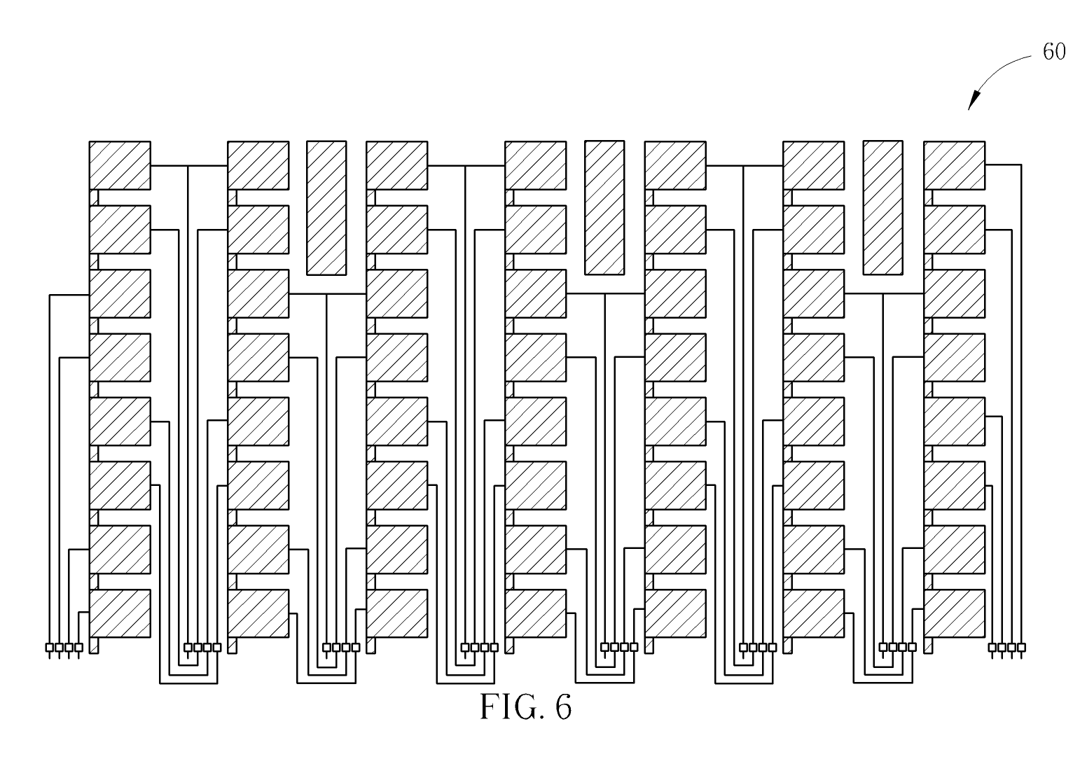

An embodiment of the classification method is illustrated in a single-layer mutual capacitive touch screen 50 shown in FIG. 5. In the single-layer mutual capacitive touch screen 50, the number and disposition of the touch sensing electrodes are similar to those shown in FIG. 3, which also has 32 touch sensing electrodes arranged in an 8×4 array, but the disposition method of driving wires and output pins in the single-layer mutual capacitive touch screen 50 is different from that in the single-layer mutual capacitive touch screen 30. As shown in FIG. 5, in the 1^{st}, 2^{nd}, 5^{th} and 6^{th} rows, the touch sensing electrodes located at the 1^{st} column and the 2^{nd} column share an output pin, and the touch sensing electrodes located at the 3^{rd} column and the 4^{th} column share an output pin. In the 3^{rd}, 4^{th}, 7^{th} and 8^{th} rows, the touch sensing electrodes located at the 2^{nd} column and the 3^{rd} column share an output pin, each touch sensing electrode located at the 1^{st} column is connected to an output pin separately from the left side, and each touch sensing electrode located at the 4^{th} column is connected to an output pin separately from the right side. The main difference between the single-layer mutual capacitive touch screen 50 and the single-layer mutual capacitive touch screen 30 is that in the single-layer mutual capacitive touch screen 30, the touch sensing electrodes in the first group are those located at odd rows, and the touch sensing electrodes in the second group are those located at even rows; in the single-layer mutual capacitive touch screen 50, the touch sensing electrodes in the first group are those located at the a^{th} row of the array wherein └(a+1)/2┘ is an odd number, and the touch sensing electrodes in the second group are those located at the b^{th} row of the array wherein └(b+1)/2┘ is an even number. Similarly, the touch sensing electrodes located at the a^{th} row where └(a+1)/2┘ is an odd number may also be classified into the second group, and the touch sensing electrodes located at the b^{th} row where └(b+1)/2┘ is an even number may be classified into the first group, which is not limited herein. The disposition method of the connecting wires and output pins in the single-layer mutual capacitive touch screen 50 may also achieve the reduction of output pin numbers and connecting wire numbers. Such effects are similar to those achieved in the single-layer mutual capacitive touch screen 30, and will not be narrated herein. The touch sensing electrodes in the single-layer mutual capacitive touch screen 40 and arranged in an 8×7 array may also be classified according to the method shown in FIG. 5, and the related disposition is illustrated in FIG. 6.

As mentioned above, in the embodiments of the present invention, at least one row of touch sensing electrodes in one group may be disposed between at least two rows of touch sensing electrodes in the other group, in order to achieve interleaving; hence, the resistance distribution of connecting wires becomes more uniform, and the visual uniformity of the screen will also be better. More specifically, in some embodiments, the first group may include the touch sensing electrodes located at the c^{th} row and the e^{th} row, and the second group may include the touch sensing electrodes located at the d^{th} row, where c<d<e. Similarly, in other embodiments, the second group may include the touch sensing electrodes located at the c^{th} row and the e^{th} row, and the first group may include the touch sensing electrodes located at the d^{th} row, where c<d<e. As a result, the interleaving arrangement with the first group and the second group allows the resistance distribution of connecting wires to be more uniform, and prevents a large area of optical compensation from causing visual non-uniformity.

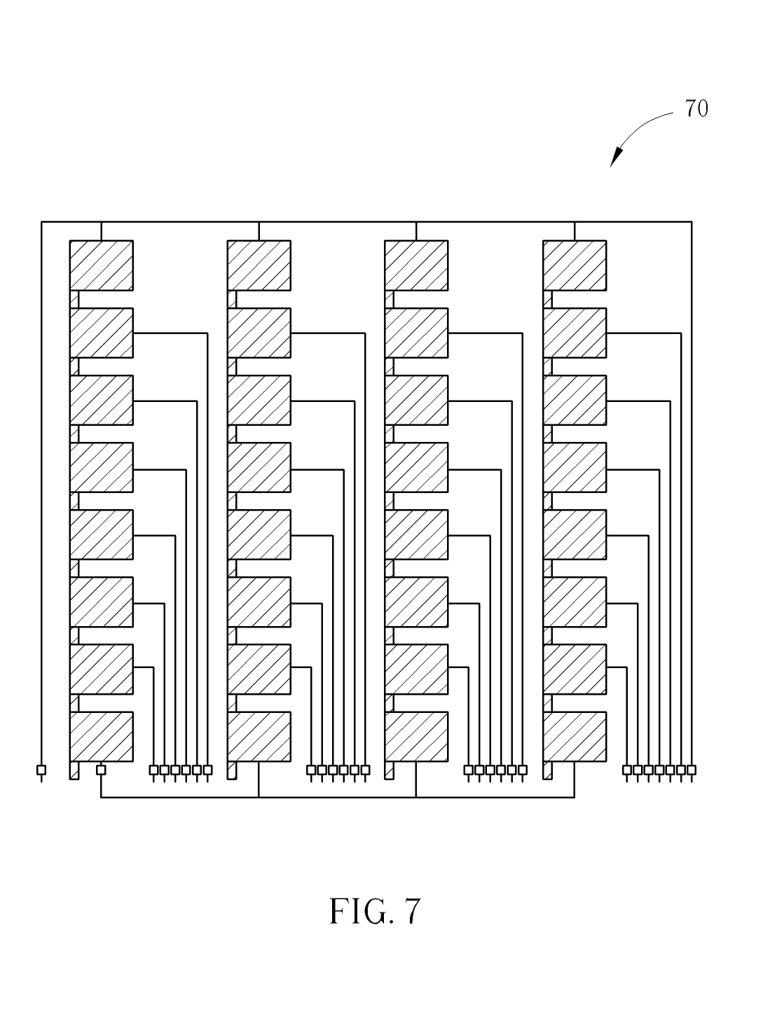

Please note that, in the above single-layer mutual capacitive touch screens, the touch sensing electrodes are classified into two groups, and two touch sensing electrodes share one output pin, in order to achieve the reduction of output pins. In some embodiments, the touch sensing electrodes may also share the output pins in other manners, which are not limited herein. For example, please refer to FIG. 7, which is a schematic diagram of the disposition of touch sensing electrodes in a single-layer mutual capacitive touch screen 70 according to an embodiment of the present invention. As shown in FIG. 7, each touch sensing electrode located at the 1^{st} row is connected to each other via a driving wire, and then connected to a corresponding output pin, in order to share the output pin. Each touch sensing electrode located at the N^{th} row may also be connected to each other via a driving wire, and then connected to a corresponding output pin, in order to share the output pin. In other words, the driving wires for connecting the touch sensing electrodes located at the 1^{st} row and the N^{th} row can connect outside of the N×M array; hence, all touch sensing electrodes located at the same row can share an output pin, which will not be limited to two touch sensing electrodes sharing one output pin. In such a condition, the driving method of the single-layer mutual capacitive touch screen may input driving signals to the driving areas horizontally and receive touch sensing signals vertically; hence, the receiving areas within the touch sensing electrodes from top to bottom can be connected to each other, and the driving areas within the touch sensing electrodes from left to right can also be connected to each other. Since the driving wires for the touch sensing electrodes located at the 1^{st} row and the N^{th} row can be connected outside of the N×M array without overlapping, all touch sensing electrodes located at the same row can share the output pin. Please note that, corresponding to the driving wire for the 1^{st} row, there is one output pin disposed at the left side of the N×M array and one disposed at the right side, which is utilized for reducing the impedance of driving wire (since this shared driving wire is longer). In other embodiments, the touch screen may use only one or any number of output pins to realize the transmission of driving signals.

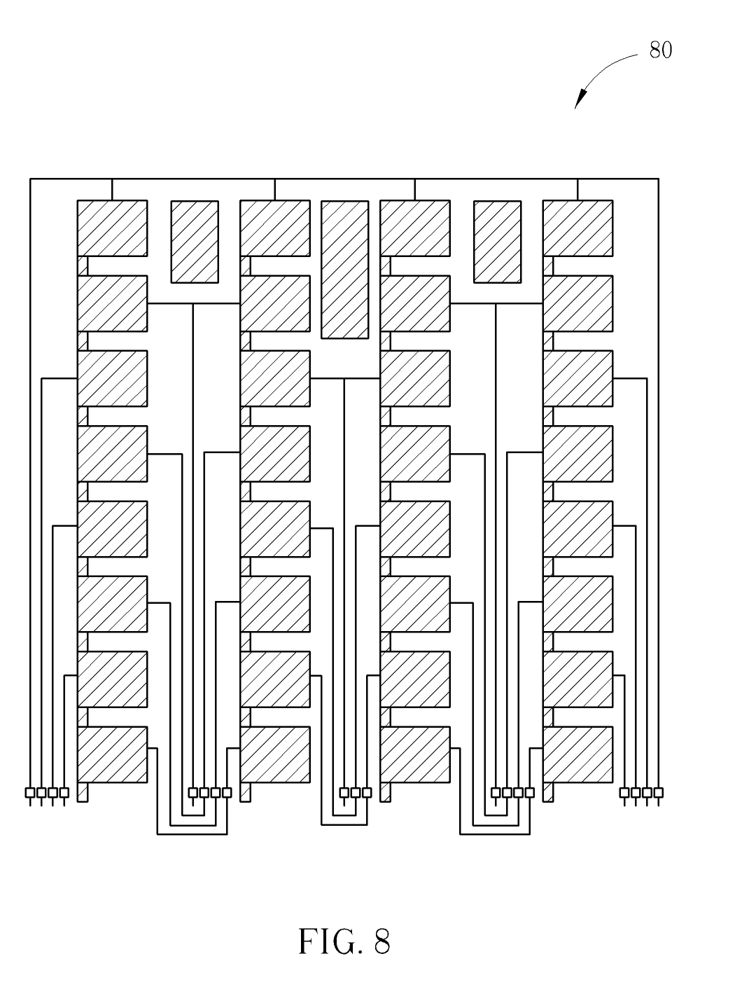

The above sharing method of driving wires and output pins for the touch sensing electrodes located at the 1^{st} row and the N^{th} row can further be combined with the abovementioned methods of classification and the sharing of two touch sensing electrodes. Please refer to FIG. 8, which is a schematic diagram of the disposition of touch sensing electrodes in a single-layer mutual capacitive touch screen 80 according to an embodiment of the present invention. As shown in FIG. 8, the number and disposition of the touch sensing electrodes in the single-layer mutual capacitive touch screen 80 are similar to those in the single-layer mutual capacitive touch screens 30, 50 and 70, which also has 32 touch sensing electrodes arranged in an 8×4 array, but the disposition method of driving wires and output pins in the single-layer mutual capacitive touch screen 80 is different from those in the single-layer mutual capacitive touch screens 30, 50 and 70. In the single-layer mutual capacitive touch screen 80, the disposition of driving wires and output pins for the touch sensing electrodes located from the 2^{nd} row to the N^{th} row are all classified by odd rows and even rows according to the above method, except that the driving wire for each touch sensing electrode located at the 1^{st} row is connected at the top of the N×M array, and then drawn downward to the output pins below from the left side and the right side, respectively. In such a situation, originally 3 output pins are required for the 1^{st} row (corresponding to one touch sensing electrode located at the 1^{st} column, one shared by the 2^{nd} and 3^{rd} columns, and one located at the 4^{th} column, respectively), and in this embodiment, only 2 output pins are required. When the number of output pins corresponding to touch sensing electrodes located at other rows is fixed, 1 output pin may further be saved in comparison with the single-layer mutual capacitive touch screen 30, i.e. the disposition method of connecting wires utilized in the single-layer mutual capacitive touch screen 80 only requires 23 output pins in total. Under the structure of the single-layer mutual capacitive touch screen 30, 7 driving wires are disposed between the 2^{nd} column and the 3^{rd} column. After the disposition for the 1^{st} row is adjusted to all touch sensing electrodes sharing the output pin and connected at the top, the driving wire originally connected between the touch sensing electrodes of the 2^{nd} column and the 3^{rd} column by the 1^{st} row will no longer be connected downward via the path between the 2^{nd} column and the 3^{rd} column. The driving wires corresponding to the touch sensing electrodes located at the 2^{nd} column and the 3^{rd} column by the 3^{rd} row may be connected to each other and then connected to an output pin. Therefore, under the structure of the single-layer mutual capacitive touch screen 80, only 5 driving wires are required between the 2^{nd} column and the 3^{rd} column, as shown in FIG. 8.

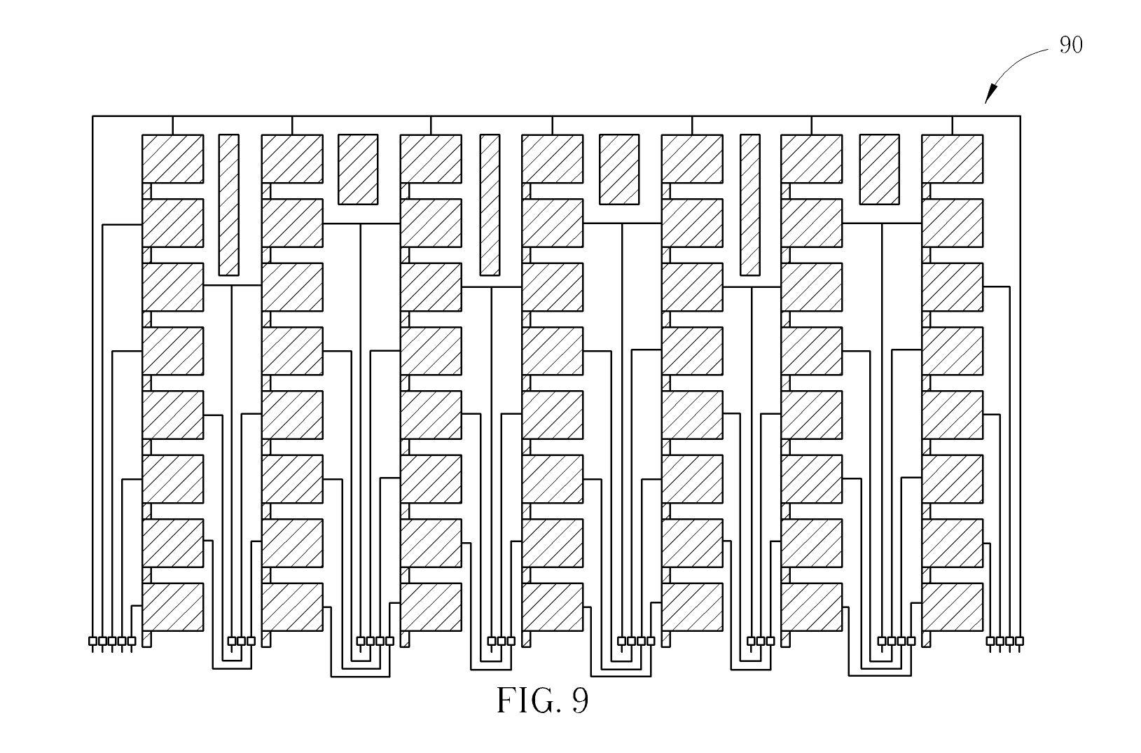

Similarly, when the above disposition method of driving wires is applied in a larger touch screen or a touch screen with more touch sensing electrodes, greater benefits will be achieved. Please refer to FIG. 9, which is a schematic diagram of the disposition of touch sensing electrodes in a single-layer mutual capacitive touch screen 90 according to an embodiment of the present invention. As shown in FIG. 9, the number and disposition of the touch sensing electrodes in the single-layer mutual capacitive touch screen 90 are similar to those in the single-layer mutual capacitive touch screens 40 and 60, which also has 56 touch sensing electrodes arranged in an 8×7 array, but the disposition of driving wires and output pins in the single-layer mutual capacitive touch screen 90 is performed according to the above method where all touch sensing electrodes located at the 1^{st} row share both an output pin and driving wire. The driving wires and output pins corresponding to the touch sensing electrodes located at the 2^{nd} and following rows are disposed using the classification of odd rows and even rows and the sharing by two touch sensing electrodes. In such a situation, 4 output pins are originally required for the 1^{st} row (corresponding to one touch sensing electrode shared by the 1^{st} and 2^{nd} columns, one shared by the 3^{rd} and 4^{th} columns, one shared by the 5^{th} and 6^{th} columns, and one located at the 7^{th} column, respectively), whereas in this embodiment, only 2 output pins are required. When the number of output pins corresponding to touch sensing electrodes located at other rows is fixed, 2 output pins may further be saved here in comparison with the single-layer mutual capacitive touch screen 40, i.e. the disposition method of connecting wires utilized in the single-layer mutual capacitive touch screen 90 only requires 37 output pins in total. Only 5 driving wires are required between the 1^{st} column and the 2^{nd} column, the 3^{rd} column and the 4^{th} column, and the 5^{th} column and the 6^{th} column. In comparison, in the single-layer mutual capacitive touch screen 40, 7 driving wires are disposed between every two columns of touch sensing electrodes on average. Under the structure of the single-layer mutual capacitive touch screen 90, the disposition may further be reduced to 6 driving wires between every two columns of touch sensing electrodes on average. As a result, the disposition density of touch sensing electrodes will be increased, which further enhances the touch sensitivity.

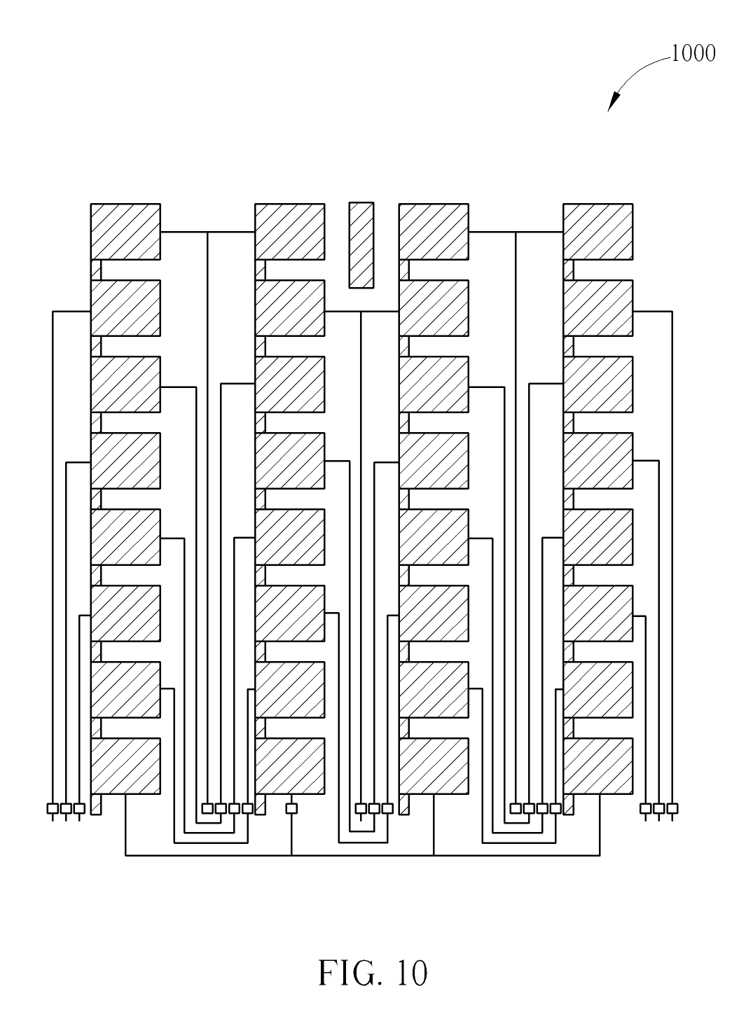

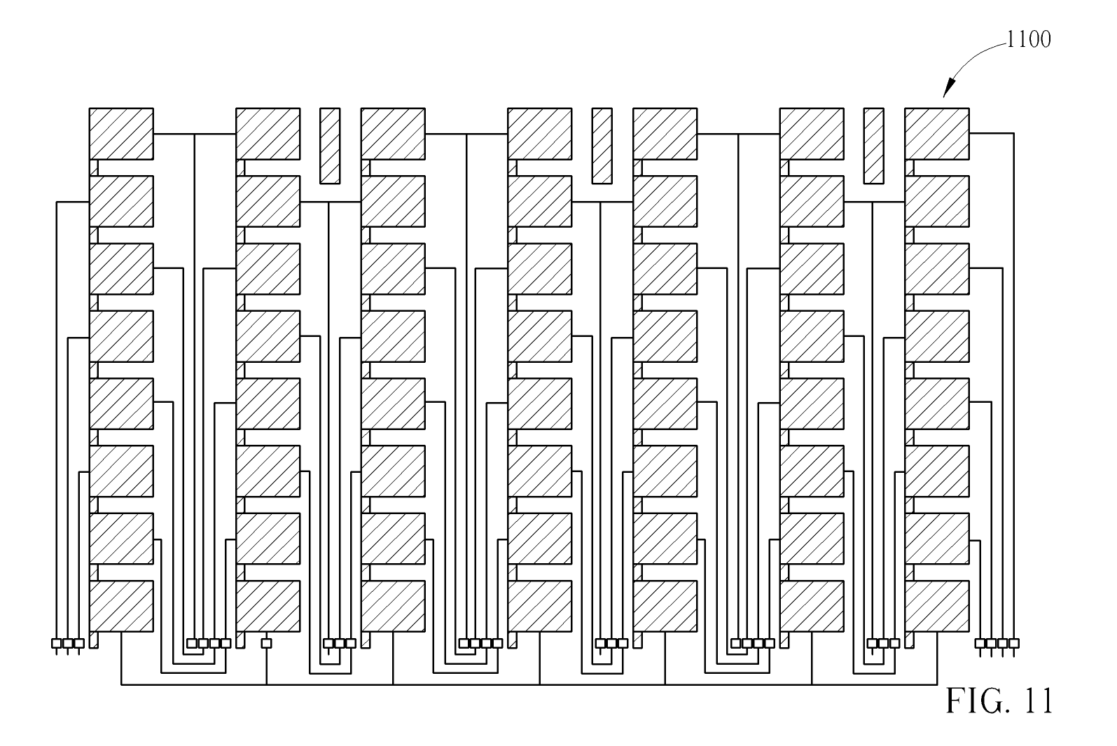

Please refer to FIG. 10, which is a schematic diagram of the disposition of touch sensing electrodes in a single-layer mutual capacitive touch screen 1000 according to an embodiment of the present invention. As shown in FIG. 10, the number and disposition of the touch sensing electrodes in the single-layer mutual capacitive touch screen 1000 are similar to those in the single-layer mutual capacitive touch screens 30, 50, 70 and 80, which also has 32 touch sensing electrodes arranged in an 8×4 array, but the disposition method of driving wires and output pins in the single-layer mutual capacitive touch screen 1000 is different from that in the single-layer mutual capacitive touch screens 30, 50, 70 and 80. In the single-layer mutual capacitive touch screen 1000, the disposition of driving wires and output pins for the touch sensing electrodes located from the 1^{st} row to the (N−1)^{th} row are all classified by odd rows and even rows according to the above method, except that the driving wire for each touch sensing electrode located at the N^{th} row is connected below the N×M array, and then connected to an output pin. In such a situation, 3 output pins are originally required for the N^{th} row (corresponding to one touch sensing electrode located at the 1^{st} column, one shared by the 2^{nd} and 3^{rd} columns, and one located at the 4^{th} column, respectively), whereas in this embodiment, only 1 output pin is required. When the number of output pins corresponding to touch sensing electrodes located at other rows is fixed, 2 output pins may further be saved here in comparison with the single-layer mutual capacitive touch screen 30, i.e. the disposition method of connecting wires utilized in the single-layer mutual capacitive touch screen 1000 only requires 22 output pins in total. Under the structure of the single-layer mutual capacitive touch screen 1000, only 5 driving wires are required between the 2^{nd} column and the 3^{rd} column. Similarly, such a disposition method for the driving wires may also be applied in a larger touch screen or a touch screen with more touch sensing electrodes, as shown in FIG. 11. In the single-layer mutual capacitive touch screen 1100 shown in FIG. 11, there are 56 touch sensing electrodes arranged in an 8×7 array, and only 36 output pins are required in total. The yield rate can therefore be improved and cost will be reduced. Only 6 driving wires are required between every two columns of touch sensing electrodes on average, so that the disposition density of touch sensing electrodes will also be increased and the touch sensitivity can be enhanced. Detailed descriptions related to the single-layer mutual capacitive touch screen 1100 are available by reference to the abovementioned content together with FIG. 11, and will therefore not be narrated herein.

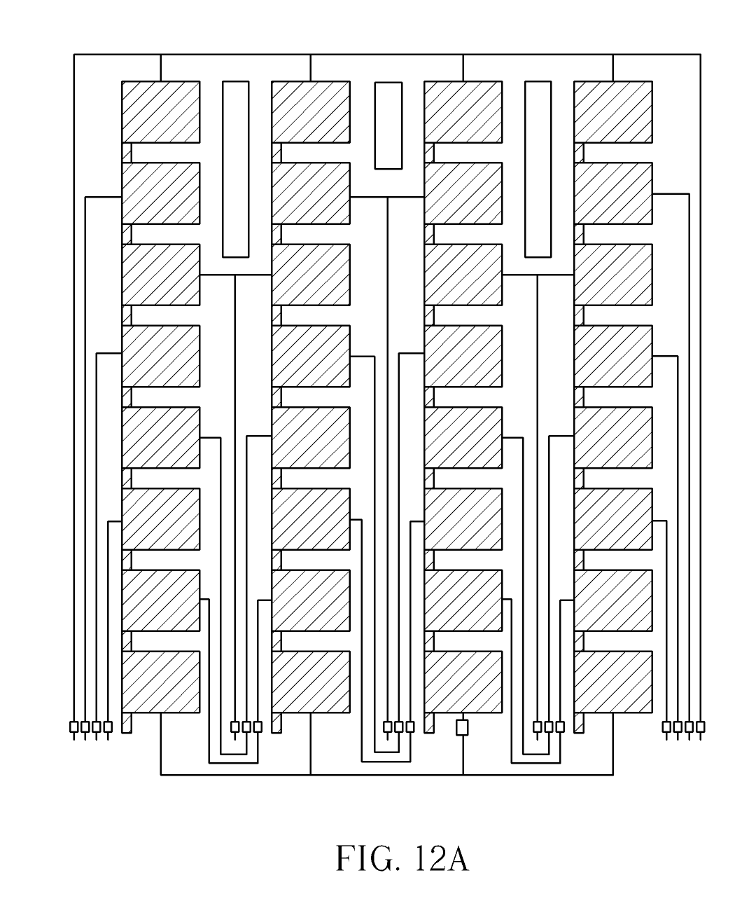

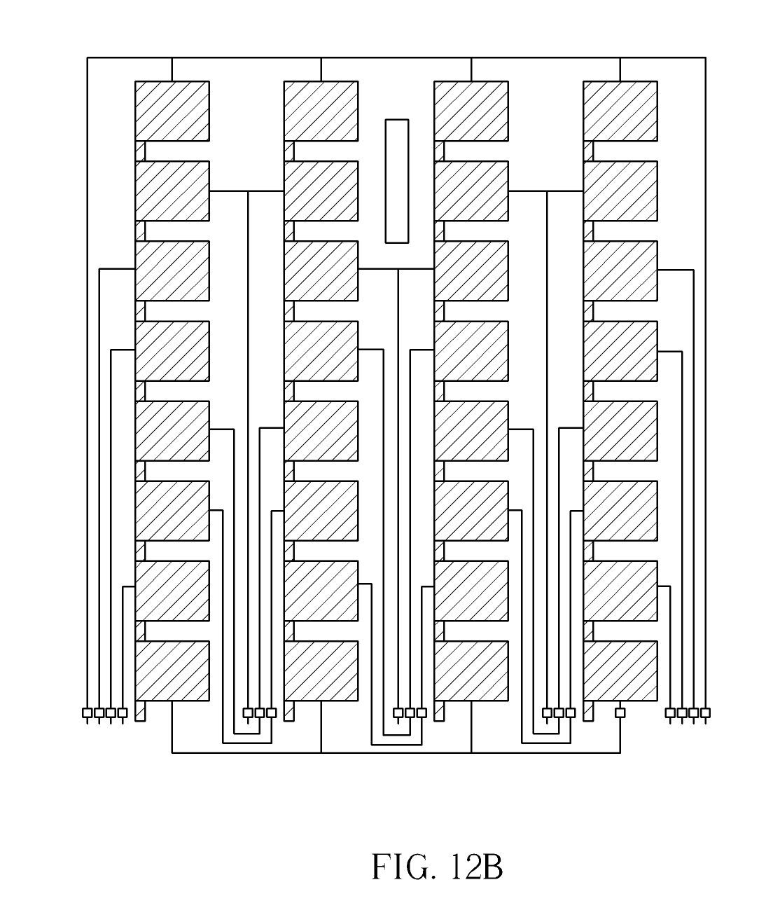

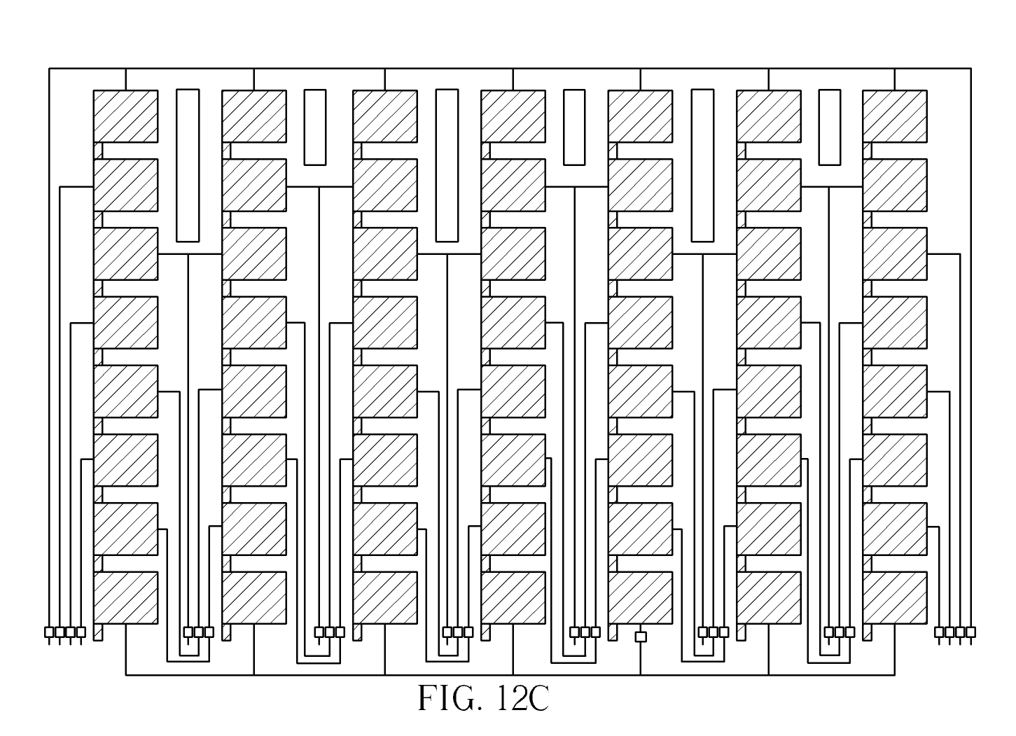

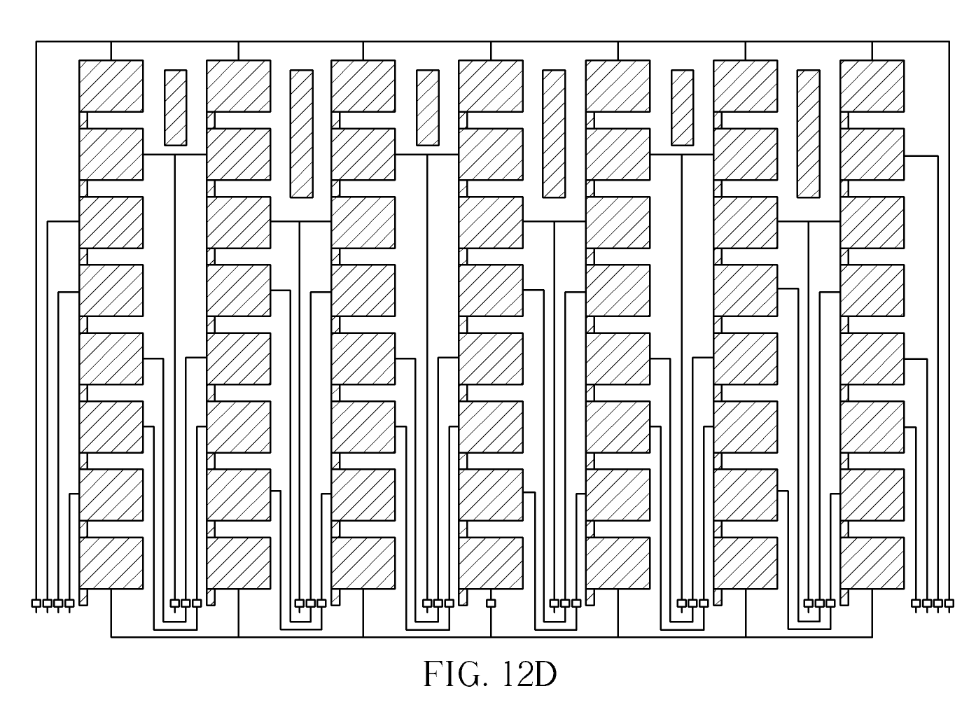

Please note that the various methods mentioned above for reducing the number of output pins can be implemented together, in order to achieve a better effect. For example, please refer to FIG. 12A to FIG. 12D, which illustrate single-layer mutual capacitive touch screens using multiple methods of sharing the output pins. In the single-layer mutual capacitive touch screens illustrated in FIG. 12A to FIG. 12D, the driving wire for each touch sensing electrode located at the 1^{st} row is connected at the top of the N×M array, and then drawn downward to the output pins below from the left side and the right side, respectively, in order to share the output pins. The driving wire for each touch sensing electrode located at the N^{th} row is connected below the N×M array, and then connected to an output pin, in order to share the output pin. The disposition of driving wires and output pins for touch sensing electrodes located at other rows are performed according to the methods of interleaving classification and sharing by two touch sensing electrodes. As a result, the number of output pins can further be reduced, and the number of driving wires disposed between every two columns may also be reduced, in order to increase the disposition density of touch sensing electrodes, which in turn enhances the touch sensitivity. For example, in FIG. 12A and FIG. 12B, the single-layer mutual capacitive touch screen has 32 touch sensing electrodes arranged in an 8×4 array. When multiple methods of sharing output pins and connecting wires are applied, only 22 output pins are required in total, and only 5 driving wires are disposed between every two columns of touch sensing electrodes on average. In FIG. 12C and FIG. 12D, the single-layer mutual capacitive touch screen has 56 touch sensing electrodes arranged in an 8×7 array. When multiple methods of sharing output pins and connecting wires are applied, only 34 output pins are required in total, and only 5 driving wires are disposed between every two columns of touch sensing electrodes on average.

In the prior art, the touch sensing electrodes of the single-layer mutual capacitive touch screen with multi-touch functions and the connecting wires for the control devices have to be realized on the same layer of the substrate. Different wires corresponding to different touch sensing electrodes cannot overlap on the substrate. In such a situation, a great number of connecting wires should be disposed on the substrate, which decreases the area for disposing the touch sensing electrodes, such that sensitivity and linearity of touch sensing will be reduced. In addition, such a single-layer structure requires a great number of output pins disposed on the substrate to connect the circuits on the substrate to external control devices. The great number of output pins will lead to higher cost and lower yield rate. In comparison, the embodiments of the present invention can reduce the numbers of output pins and connecting wires for the touch sensing electrodes by disposition of the connecting wires and share of the output pins, in order to achieve the benefits of cost reduction, yield rate improvement and touch sensitivity enhancement. For the touch sensing electrodes arranged in an 8×4 array, the prior art requires 36 output pins in total, and 8 driving wires disposed between every two columns of touch sensing electrodes; the embodiments of the present invention can reduce the number of output pins to 22, and require only 5 driving wires disposed between every two columns of touch sensing electrodes on average. For the touch sensing electrodes arranged in an 8×7 array, the prior art requires a total of 63 output pins, and 8 driving wires disposed between every two columns of touch sensing electrodes; the embodiments of the present invention can reduce the number of output pins to 34, and require only 5 driving wires disposed between every two columns of touch sensing electrodes on average. The methods of interleaving classification and sharing by two touch sensing electrodes according to the embodiments of the present invention allow the linear resistance of the connecting wires to be distributed uniformly, and further prevent a large area of optical compensation from causing visual non-uniformity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A single-layer mutual capacitive touch screen, comprising:
a substrate;
a control circuit, disposed at a side of the substrate;
a plurality of touch sensing electrodes, arranged on the substrate in an N×M array and classified into a first group and a second group, wherein touch sensing electrodes among the plurality of touch sensing electrodes located in a same row are classified into a same group;
a plurality of output pins, located at the side of the substrate, for connecting the control circuit to the plurality of touch sensing electrodes; and
a plurality of driving wires, each connecting a touch sensing electrode among the plurality of touch sensing electrodes to an output pin among the plurality of output pins, respectively;
wherein in the first group, each touch sensing electrode located at odd columns of the N×M array substantially shares an output pin with an adjacent touch sensing electrode located in a first direction of the touch sensing electrode;
wherein in the second group, each touch sensing electrode located at even columns of the N×M array substantially shares an output pin with an adjacent touch sensing electrode located in the first direction of the touch sensing electrode;
wherein at least one row of touch sensing electrodes in the second group are located between at least two rows of touch sensing electrodes in the first group.

2. The single-layer mutual capacitive touch screen of claim 1, wherein in a specific row of the first group, each touch sensing electrode located at odd columns of the N×M array is connected to an adjacent touch sensing electrode located in the first direction of the touch sensing electrode and connected to an output pin via a driving wire, in order to share the output pin.

3. The single-layer mutual capacitive touch screen of claim 2, wherein in the first group, each touch sensing electrode located at odd columns of the N×M array except those located at the specific row and an adjacent touch sensing electrode located in the first direction of the touch sensing electrode are respectively connected to an output pin, in order to share the output pin.

4. The single-layer mutual capacitive touch screen of claim 1, wherein in a specific row of the second group, each touch sensing electrode located at even columns of the N×M array is connected to an adjacent touch sensing electrode located in the first direction of the touch sensing electrode and connected to an output pin via a driving wire, in order to share the output pin.

5. The single-layer mutual capacitive touch screen of claim 4, wherein in the second group, each touch sensing electrode located at even columns of the N×M array except those located at the specific row and an adjacent touch sensing electrode located in the first direction of the touch sensing electrode are respectively connected to an output pin, in order to share the output pin.

6. The single-layer mutual capacitive touch screen of claim 1, wherein the first direction is a direction with an increasing column number corresponding to the N×M array.

7. The single-layer mutual capacitive touch screen of claim 6, wherein when M is an odd number, each touch sensing electrode in the first group located at the M^{th} column of the N×M array is connected to an output pin separately, and when M is an even number, each touch sensing electrode in the second group located at the M^{th} column of the N×M array is connected to an output pin separately.

8. The single-layer mutual capacitive touch screen of claim 6, wherein each touch sensing electrode in the second group located at the first column of the N×M array is connected to an output pin separately.

9. The single-layer mutual capacitive touch screen of claim 1, wherein touch sensing electrodes in the first group are located at odd rows of the N×M array, and touch sensing electrodes in the second group are located at even rows of the N×M array.

10. The single-layer mutual capacitive touch screen of claim 1, wherein touch sensing electrodes in the first group are located at even rows of the N×M array, and touch sensing electrodes in the second group are located at odd rows of the N×M array.

11. The single-layer mutual capacitive touch screen of claim 1, wherein touch sensing electrodes in the first group are located at the a^{th} row of the N×M array, wherein └(a+1)/2┘ is an odd number, and touch sensing electrodes in the second group are located at the b^{th} row of the N×M array, wherein └(b+1)/2┘ is an even number.

12. The single-layer mutual capacitive touch screen of claim 1, wherein touch sensing electrodes in the first group are located at the a^{th} row of the N×M array, wherein └(a+1)/2┘ is an even number, and touch sensing electrodes in the second group are located at the b^{th} row of the N×M array, wherein └(b+1)/2┘ is an odd number.

13. The single-layer mutual capacitive touch screen of claim 1, further comprising a plurality of receiving wires, for connecting two adjacent touch sensing electrodes in each column of the N×M array, and connecting a touch sensing electrode closest to the side of the substrate with a corresponding output pin.

14. A single-layer mutual capacitive touch screen, comprising:
a substrate;
a control circuit, disposed at a side of the substrate;
a plurality of touch sensing electrodes, arranged on the substrate in an N×M array;
a plurality of output pins, located at the side of the substrate, for connecting the control circuit to the plurality of touch sensing electrodes; and
a plurality of driving wires, each connecting a touch sensing electrode among the plurality of touch sensing electrodes to an output pin among the plurality of output pins, respectively;
wherein each touch sensing electrode located at the first row of the N×M array is connected to each other via a driving wire, and connected to a corresponding output pin;
wherein each touch sensing electrode located at the N^{th} row of the N×M array is connected to each other via a driving wire, and connected to a corresponding output pin.

15. The single-layer mutual capacitive touch screen of claim 14, wherein the side of the substrate is outside of the N^{th} row of the N×M array.

16. The single-layer mutual capacitive touch screen of claim 14, further comprising a plurality of receiving wires, for connecting two adjacent touch sensing electrodes in each column of the N×M array, and connecting a touch sensing electrode closest to the side of the substrate with a corresponding output pin.
